(19) United States
(12) Patent Application Publication
(10) Pub. No.: US 2012/0311312 A1
(43) Pub. Date: Dec. 6, 2012

(54) Fast Boot Via State Recreation

(75) Inventor: Farooq (Muhammad) Hameed, Parkland, FL (US)

(73) Assignee: Broadcom Corporation, Irvine, CA (US)

(21) Appl. No.: 13/149,382

(22) Filed: May 31, 2011

(51) Int. Cl. G06F 15/177

(52) U.S. Cl. 713/2

(57) ABSTRACT

Methods, systems, and computer program products are provided to improve performance in power-saving modes. In particular, improvements are detailed to initialization times after chip restart from a power down mode. These improved initialization times benefit many consumer electronics that rely on batteries and other onboard power supplies, while at the same time having to meet strict usability demands for system response times.

### BACKGROUND OF THE INVENTION

1. Field of the Invention

The present invention relates generally to power saving and, in particular, to performance efficiencies related to power saving mode operation, and also to addressing power-on and startup latency.

2. Background Art

Complex electronic devices, such as many consumer electronics, are often built from off-the-shelf parts, or components that are otherwise designed and built to a non-device-specific specification. By way of non-limiting example, Bluetooth devices (e.g., human interface devices (“HID”)) typically rely on readily-available off-the-shelf parts to implement Bluetooth communications, rather than reinventing the wheel. This practice is seen in many device design and manufacture environments, including the use of off-the-shelf parts for other communications protocols (e.g., USB, Ethernet, etc.).

A concern with many of these devices is power usage, especially during periods of inactivity. For example, Bluetooth devices generally draw power from an on-board power source so the device can operate wirelessly. Efficient usage and management of the on-board power source to maximize longevity can have a significant impact on whether the device will be usable or unusable for its intended purpose. Efficient usage and management of power is also beneficial in environments with unlimited or neatly-unlimited access to power for environmental reasons.

One way to reduce power consumption is to effectively shut down power to all portions of such a device, except to a component specifically tasked with restoring power upon receipt of a signal. While this approach is suitable to significantly reduce power usage, hardware and firmware/software components will often require significant initialization times before they are available for usage. This is detrimental in many HID applications, including keyboards and mice. If a wireless keyboard's Bluetooth module has been powered down, and is powered back up when a user enters a keystroke on the keyboard, a significant and perceptible delay occurs before the keyboard is once again active and ready to accept inputs. This is caused at least in part by the Bluetooth module (and perhaps other modules) having to go through an initialization process upon start up.

Due to the difficulties and delays associated with the aforementioned power saying approach, despite the power saving efficiencies, a more common approach is to instead provide gated clock signals. By passing clock signals, used to drive the timing of various modules such as the aforementioned Bluetooth module, through a gating mechanism, it is possible to avoid power consumption due to state changes (e.g., power consumption due to driving a ‘1’ or ‘high’ signal on a line rather than a ‘0’ or low').

This approach has the benefit that, when the clock signal is disabled, the current state of various modules in the device is retained. Accordingly, initialization (by re-enabling the clock signal) is relatively rapid. However, this approach does not provide the significant power savings realized by the earlier approach. For example, maintaining the state of volatile memory consumes power, which could be avoided by the earlier approach of re-initializing the entire device whenever it is needed, while shutting down power almost entirely when it is not needed.

Accordingly, what is desired is systems and methods that provide the power-saving benefits of completely shutting down power to several hardware modules, while providing a response time that is acceptable to users.

### BRIEF SUMMARY OF THE INVENTION

Embodiments of the invention include a method comprising receiving a notification to recover from a power-down state, retrieving initialized state information from a non-volatile memory, responsive to receiving the notification, wherein the initialized state information corresponds to a deterministic initialization state, and applying, by a computing device, the initialized state information to corresponding locations in a volatile memory.

Additional embodiments of the invention include a computer-readable medium having stored thereon computer-executable instructions, execution of which, by computing device, causes the computing device to perform operations comprising receiving a notification to recover from a power-down state, retrieving initialized state information from a non-volatile memory, responsive to receiving the notification, wherein the initialized state information corresponds to a deterministic initialization state, and applying the initialized state information to corresponding locations in a volatile memory.

Further embodiments of the invention include a system comprising a non-volatile memory configured to store initialized state information corresponding to a deterministic initialization state, a volatile memory, and one or more modules configured to receive a notification to recover from a power-down state, retrieve the initialized state information from the non-volatile memory responsive to receiving the notification, and apply the initialized state information to corresponding locations in the volatile memory.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present invention and, together with the description, further serve to explain the principles of the invention and to enable a person skilled in the relevant art to make and use the invention.

FIGS. 1A and 1B illustrate hardware components used in state recreation, in accordance with some embodiments of the present invention.

FIG. 2 is a flowchart illustrating steps by which an initialized state is preserved, in accordance with some embodiments of the present invention.

FIG. 3 is a flowchart illustrating steps by which initialization state information is used to accelerate booting, in accordance with some embodiments of the present invention.

FIG. 4 is a flowchart illustrating steps by which an initialized firmware or software state is preserved, in accordance with some embodiments of the present invention.

FIG. 5 is a flowchart illustrating steps by which initialization state information is used to accelerate firmware or software application startup, in accordance with some embodiments of the present invention.

FIG. 6 depicts an example computer system in which embodiments of the present invention may be implemented.

The present invention will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION OF THE INVENTION

### I. Introduction

The following detailed description of the present invention refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Any actual software code with the specialized control of hardware to implement the present invention is not limiting of the present invention. Thus, the operational behavior of the present invention will be described with the understanding that modifications and variations of the embodiments are possible, and within the scope and spirit of the present invention.

Reference to modules in this specification and the claims means any combination of hardware or software components for performing the indicated function. A module need not be a rigidly defined entity, such that several modules may overlap hardware and software components in functionality. For example, a software module may refer to a single line of code within a procedure, the procedure itself being a separate software module. One skilled in the relevant arts will understand that the functionality of modules may be defined in accordance with a number of stylistic or performance-optimizing techniques, for example.

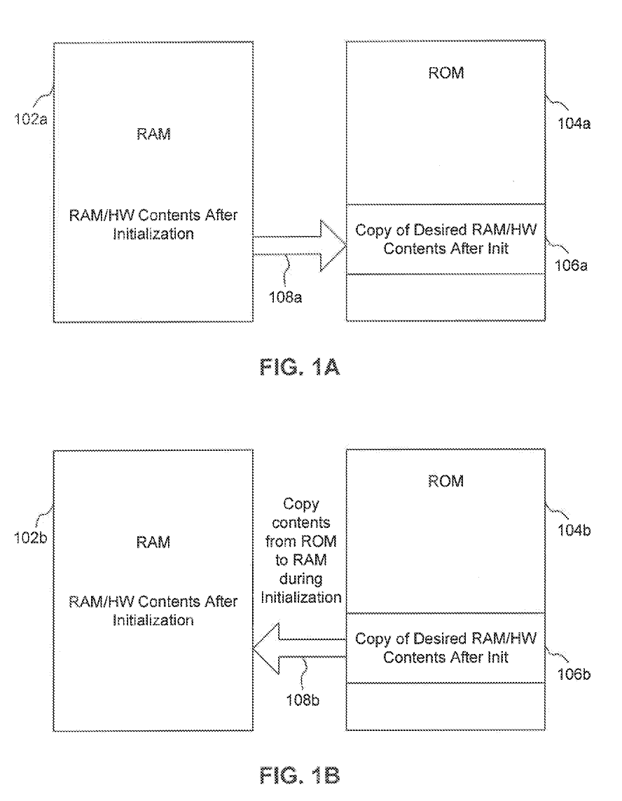

FIG. 1 illustrates hardware components used in state recreation, in accordance with some embodiments of the present invention. FIG. 1A shows a volatile memory such as RAM 102a and a non-volatile memory, such as ROM 104a. After a hardware component has been initialized, the contents of RAM (and other volatile memory storage locations, including, but not limited to, hardware registers) are written 108a to a designated area 106a of ROM 104a. On a subsequent initialization, RAM 102b is powered up, and its contents (along with the contents of any other volatile storage memory locations) are retrieved 108b from designated area 106b of ROM 104b.

In accordance with a non-limiting embodiment of the present invention, volatile 102 and non-volatile 104 memories are found in a hardware module, such as a Bluetooth HID chip. These include, by way of non-limiting example, the 20702, 20730, 20732, and 2.0741 BT HID chips manufactured by BROADCOM CORPORATION of Irvine, Calif.

The hardware interactions depicted in FIGS. 1A and 1B will now be described in further detail below.

### II. Storing Initialization State

When a chip is first powered up or reset, on-chip firmware (e.g., ROM) performs a complete initialization of all system components. This may include, by way of non-limiting example, initialization of an operating system, initialization of intertask communications (message queues, message buffers, semaphores, events, etc.), creation and initialization of system threads and tasks, initialization of drivers, hardware initialization, and buffer initialization. This initialization is necessary before the chip can perform any significant activity. For example, when a Bluetooth chip is first powered up or reset, a number of such initialization processes must take place and complete before the chip is available to communicate with a host.

For an end-user working on a device with such a chip (e.g., a HID such as a wireless keyboard) delays associated with the aforementioned initialization process are perceptible, and detract from the user experience. Some of the more efficient chips may take 100 ms to initialize, while others may take upwards of half-a-second. Such a delay is unacceptable to an end user who expects a keyboard to respond nearly instantly when input is provided. Moreover, power consumption is needlessly extended for the duration of the initialization process, negating some of the benefits of shutting down power to the chip in the first place.

As such initialization takes place whenever a chip is powered down and then back up again, a typical solution is to not fully power down the chip and obtain power savings from clock gating. However, it would be beneficial to obtain the benefits of the ability to power down a chip (such as a Bluetooth HID chip) for added power savings while at the same time remedying the lengthy initialization times.

After carefully considering the myriad uses for off-the-shelf devices such as the aforementioned Bluetooth IUD chips, it is observed that for their common applications, many if not all of the initialization steps are performed in a deterministic manner. This means that, by way of example, any given chip will transition through a same set of states (if represented as a finite state machine, for example) at every initialization. Of interest, therefore, is the latest one of these states in an initialization process that is always part of the transition (i.e., the latest deterministic state). This state can then be stored and used to quickly recreate that initialized state on subsequent resets, in accordance with some embodiments of the present invention.

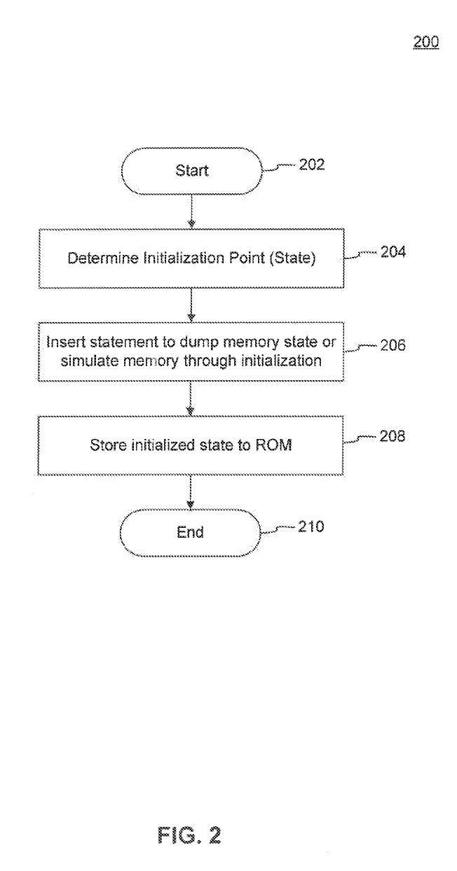

FIG. 2 is a flowchart 200 illustrating steps by which an initialized state is preserved, in accordance with some embodiments of the present invention. The method begins at step 202 and proceeds to step 204 where an initialization point (i.e., state) is determined. This is handled by, as noted above, making a determination of a state of the chip that occurs upon every restart. Initialization speeds can be further improved by carefully selecting this state to specifically be the latest deterministic state possible. In the non-limiting example of a Bluetooth HID chip, this would generally be the state immediately prior to any state capable of receiving (non-deterministic) user input. In accordance with a further embodiment of the present invention, to preserve the deterministic nature of the initialization process, any interrupts occurring during this time are deferred.

Having identified the state that will be considered the formally “initialized” state, the contents of any volatile memory (e.g., RAM, registers, etc.) defining that state need to be recovered. Step 206 outlines two possible ways to accomplish this, although alternative methodologies discernable to one of ordinary skill in the art are contemplated within the scope of this invention. In one non-limiting exemplary embodiment, the contents of volatile memory (e.g., 102a of FIG. 1A) are dumped to a file or other storage medium through the use of an instruction inserted into the chip's initialization logic at the initialized state. In another non-limiting exemplary embodiment, the expected contents of volatile memory (e.g., 102a) at the time of initialization can be determined through simulation or emulation.

Regardless of the technique used to obtain the initialization state information, the volatile memory contents are then written to a non-volatile memory (e.g., ROM 104a, typically at a designated location 106a) at step 208, and the method ends at step 210.

The method outlined in FIG. 2 would typically be accomplished by an entity involved in the fabrication/manufacture of the chip. Alternatively, it could be accomplished by a system builder that configures chips for a particular application. One skilled in the relevant arts will further recognize that the methodology could even be utilized for one-off applications by an end user with the ability to reflash the contents of a chip's non-volatile memory holding initialization information, although the discussion herein is generally directed to realizing performance and power savings across a range of applications for each target chip.

### III. State Recreation

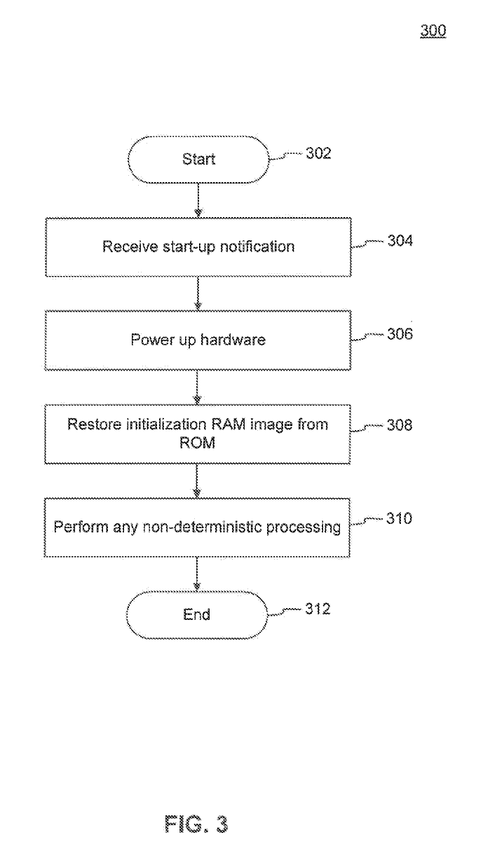

FIG. 3 is a flowchart 300 illustrating steps by which initialization state information is used to accelerate booting, in accordance with some embodiments of the present invention. As previously discussed, one of the benefits of this accelerated boot is the ability to quickly recover from a power-down state, realizing better power savings than clock-gating implementations.

The method begins at step 302 and proceeds to step 304 where the chip receives a start-up notification. In accordance with an exemplary embodiment, minimal functionality to allow the chip to receive a “wake” signal (e.g., responding to an initial keypress on a keyboard) remains powered, allowing the rest of the chip to fully power down. One skilled in the relevant arts will appreciate that other triggering mechanisms may be utilized to signal a chip to begin processing, and step 304 is provided by way of non-limiting example.

At step 306, the chip hardware is powered up. This includes, for example, powering up any volatile memory such as RAM 102b needed for processing. Then at step 308, the contents of this volatile memory are obtained from non-volatile memory, such as designated location 106b of ROM 104b. As previously discussed in further detail, the contents of the volatile memory (e.g., RAM, registers, etc.) recreated from non-volatile memory include the contents of the volatile memory at the initialized state. At this point, the chip is in the same deterministic state as it would have been had it performed the initialization process. However, it has not been necessary to actually perform all of the initialization operations. Instead, the chip is configured to be in the initialized state using data held in nonvolatile memory.

From there on, the chip is used to perform any further processing, particularly non-deterministic operations, at step 310. For example, in the case of a Bluetooth keyboard, the Bluetooth chip can be placed in an initialized state where it is ready to push received keypress data to a host device, but the contents of any such communication (or the exact keypress received), among other things, is non-deterministic and will need to be handled by the Bluetooth chip according to the circumstances. The method then ends at step 312.

Testing has shown that, in the case of the exemplary Broadcom 20730 BT HID chip, 40 kB of non-volatile memory is needed to initialize RAM and hardware registers. Copying this data on reboot to initialize the volatile memory is expected to take around 20,000 to 40,000 cycles, or approximately 1-2 ms at 24 MHz operation. This is a significant savings compared to the approximately 100 ms needed to perform the initialization process step-by-step.

### IV. Layered Approach

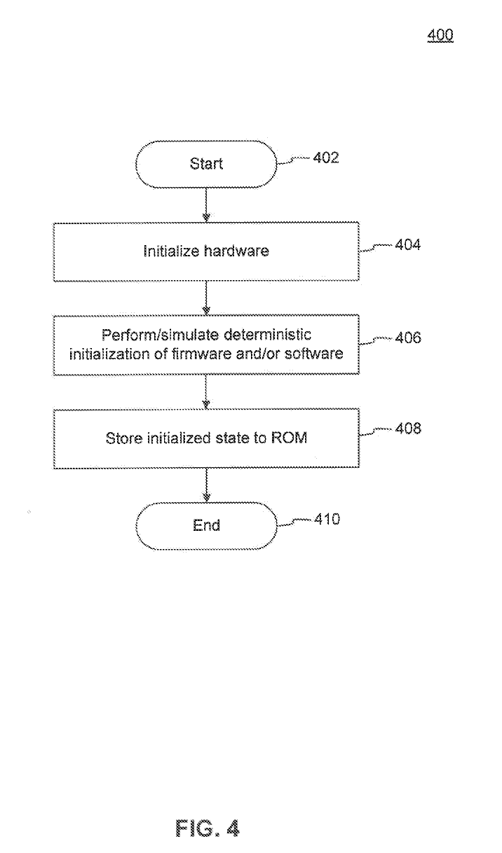

Similar techniques to the fast boot methodologies detailed above for initializing hardware can be applied to firmware and software applications, in accordance with some embodiments of the present invention. FIG. 4 is a flowchart 400 illustrating steps by which an initialized firmware or software state is preserved, in accordance with some embodiments of the present invention. The method begins at step 402, and hardware is initialized at step 404 as per usual. Then at step 406, the contents of volatile memory (e.g., RAM, registers, etc.) pertaining to a particular firmware or software application at its initialization state is obtained. This can be accomplished again through simulation/emulation, memory dump, or other techniques.

As with hardware, the initialization point would be any point (preferably the latest point) in a series of deterministic initialization states. The initialized state can then be stored to non-volatile memory (e.g., ROM 104a) at step 408. The method then ends at step 410.

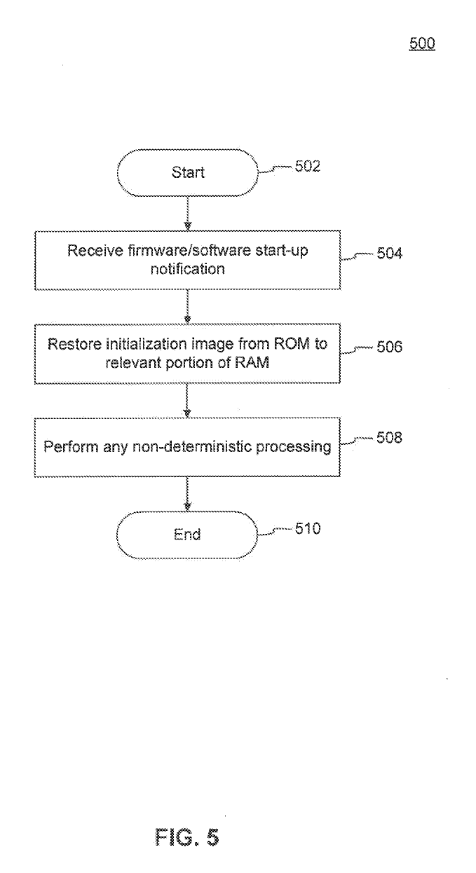

FIG. 5 is a flowchart 500 illustrating steps by which initialization state information is used to accelerate firmware or software application startup, in accordance with some embodiments of the present invention. The method begins at step 502 and proceeds to step 504 where a notification is received of firmware or software application start-up. One of ordinary skill in the relevant art will appreciate that the mechanism for such notification is application-specific.

At step 506, an image of the initialized state of the firmware or software application is retrieved from non-volatile memory (e.g., ROM) to volatile memory (e.g., RAM, registers, etc.). From then on out, the chip is ready to perform non-deterministic processing at step 508 using the firmware or software application. The method then ends at step 510.

Using this approach, various initialization phases may be layered, allowing for some deterministic processing (e.g., loading task-specific drivers, establishing communications, etc.) to be performed before initializing the next layer. In an alternative embodiment, where the same hardware, firmware, and/or software initialization takes place upon every boot-up, the state of volatile memory at the latest point of initialization (e.g., with everything fully loaded and ready) can be used as the initialized state. However, the layered approach described herein provides additional flexibility, and permits some flexibility for the chip's end-user-implementer.

### Other Considerations

In the event that certain contents cannot or should not be restored from non-volatile memory to volatile memory, this behavior is handled prior to processing beyond what would have been the initialized state (e.g., prior to any non-deterministic processing), in accordance with some embodiments of the present invention. In a non-limiting exemplary embodiment, an inability to fully restore the initialized state can be handled by restarting and proceeding with the full step-by-step initialization process and its associated delay).

In the event of patches distributed to firmware or software, the initialization state may be affected. This can be handled in a number of non-limiting ways, including running the patch after the initialization state is restored. An alternative resolution may be to ship a separate restore image together with the patch, which may be applied after the initial state recreation or may replace the initial state recreation altogether.

Additionally, when considering the state to use as the initialization state, it may be beneficial to rework the initialization code to push this state as late into the initialization process as possible to derive more improvements. One way to potentially accomplish this is to load all drivers (or other resources) during initialization (i.e., the restored state image has all the drivers or other resources already loaded). This deprives end-users of the ability to pick-and-choose which drivers to load, but provides added efficiencies in that all drivers (or at least the needed ones) are already ready to go upon image restoration. Facilities can be provided for the end-user to unload any unneeded drivers to recover volatile memory (RAM) space. An example of this is the Broadcom 20702 BT HID chip, which includes both a USB and UART interface. Both can be readied by the initialization image, even though only one is typically used. The unused interface than then lie dormant or be turned off after initialization.

### VI. Example Computer System Implementation

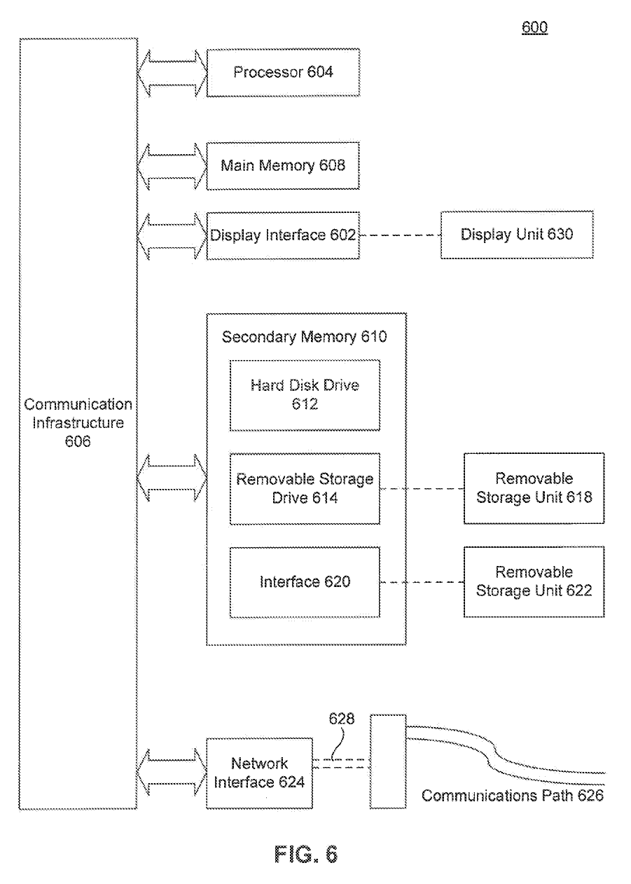

Various aspects of the present invention can be implemented by software, firmware, hardware, or a combination thereof. FIG. 6 illustrates an example computer system 600 in which the present invention, or portions thereof, can be implemented as computer-readable code. For example, the methods illustrated by flowcharts 200 of FIG. 2, 300 of FIG. 3, 400 of FIGS. 4, and 500 of FIG. 5, can be implemented in system 600. Various embodiments of the invention are described in terms of this example computer system 600. After reading this description, it will become apparent to a person skilled in the relevant art how to implement the invention using other computer systems and/or computer architectures.

Computer system 600 includes one or more processors, such as processor 604. Processor 604 can be a special purpose or a general purpose processor. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive 612, a removable storage drive 614, and/or a memory stick. Removable storage drive 614 may comprise a floppy disk drive, a magnetic tape drive, an optical disk drive, a flash memory, or the like. The removable storage drive 614 reads from and/or Writes to a removable storage unit 618 in a well known manner. Removable storage unit 618 may comprise a floppy disk, magnetic tape, optical disk, etc. that is read by and written to by removable storage drive 614. As will be appreciated by persons skilled in the relevant art(s), removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 that allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of signals that may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RE link or other communications channels.

In this document, the terms “computer program medium” and “computer usable medium” are used to generally refer to media such as removable storage unit 618, removable storage unit 622, and a hard disk installed in hard disk drive 612. Signals carried over communications path 626 can also embody the logic described herein. Computer program medium and computer usable medium can also refer to memories, such as main memory 608 and secondary memory 610, which can be memory semiconductors (e.g. DRAMs, etc.). These computer program products are means for providing software to computer system 600.

Computer programs (also called computer control logic) are stored in main memory 608 and/or secondary memory 610, Computer programs may also be received via communications interface 624. Such computer programs, when executed, enable computer system 600 to implement the present invention as discussed herein. In particular, the computer programs, when executed, enable processor 604 to implement the processes of the present invention, such as the steps in the methods illustrated by flowcharts 200 of FIG. 2, 300 of FIG. 3, 400 of FIGS. 4, and 500 of FIG. 5, discussed above. Accordingly, such computer programs represent controllers of the computer system 600. Where the invention is implemented using software, the software may be stored in a computer program product and loaded into computer system 600 using removable storage drive 614, interface 620, hard drive 612 or communications interface 624.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

### VII. Conclusion

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following, claims and their equivalents.

What is claimed is:

1. A method comprising:
receiving a notification to recover from a power-down state;
retrieving initialized state information from a non-volatile memory, responsive to receiving the notification, wherein the initialized state information corresponds to a deterministic initialization state; and
applying, by a computing device, the initialized state information to corresponding locations in a volatile memory.

2. The method of claim 1, further comprising:
retrieving application initialized state information from the non-volatile memory; and
applying the application initialized state information to a location in the volatile memory allocated to a corresponding application.

3. The method of claim 1, further comprising:
retrieving firmware initialized state information from the non-volatile memory; and
applying the firmware initialized state information to a location in the volatile memory allocated to a corresponding firmware module.

4. The method of claim 1, wherein the initialized state information has been written to the non-volatile memory using a memory dump, simulation, or emulation of contents of the volatile memory at the deterministic initialization state.

5. The method of claim 1, further comprising:
disabling interrupts until the initialized state information has been applied to the corresponding locations in the volatile memory.

6. The method of claim 1, further comprising:
writing the initialize state information to the nonvolatile memory using a memory dump, simulation, or emulation of contents of the volatile memory at the deterministic initialization state, prior to receiving the notification to recover from the power-down state.

7. A computer-readable medium having stored thereon computer-executable instructions, execution of which, by a computing device, causes the computing device to perform operations comprising:
receiving a notification to recover from a power-down state;
retrieving initialized state information from a non-volatile memory, responsive to receiving the notification, wherein the initialized state information corresponds to a deterministic initialization state; and
applying the initialized state information to corresponding locations in a volatile memory.

8. The computer-readable medium of claim 7, the operations further comprising:
retrieving application initialized state information from the non-volatile memory; and
applying the application initialized state information to a location in the volatile memory allocated to a corresponding application.

9. The computer-readable medium of claim 7, the operations further comprising:
retrieving firmware initialized state information from the non-volatile memory; and
applying the firmware initialized state information to a location in the volatile memory allocated to a corresponding firmware module.

10. The computer-readable medium of claim 7, wherein the initialized state information has been written to the non-volatile memory using a memory dump, simulation, or emulation of contents of the volatile memory at the deterministic initialization state.

11. The computer-readable medium of claim 7, the operations further comprising:
disabling interrupts until the initialized state information has been applied to the corresponding locations in the volatile memory.

12. The computer-readable medium of claim 7, the operations further comprising:
writing the initialize state information to the non-volatile memory using a memory dump, simulation, or emulation of contents of the volatile memory at the deterministic initialization state, prior to receiving the notification to recover from the power-down state.

13. A system comprising:
a non-volatile memory configured to store initialized state information corresponding to a deterministic initialization state;
a volatile memory; and
one or more modules configured to receive a notification to recover from a power-down state, retrieve the initialized state information from the non-volatile memory responsive to receiving the notification, and apply the initialized state information to corresponding locations in the volatile memory.

14. The system of claim 13, wherein the modules are further configured to retrieve application initialized state information from the non-volatile memory, and apply the application initialized state information to a location in the volatile memory allocated to a corresponding application.

15. The system of claim 13, wherein the modules are further configured to retrieve firmware initialized state information from the non-volatile memory, and apply the firmware initialized state information to a location in the volatile memory allocated to a corresponding firmware module.

16. The system of claim 13, wherein the initialized state information has been written to the non-volatile memory using a memory dump, simulation, or emulation of contents of the volatile memory at the deterministic initialization state.

17. The system of claim 13, wherein the modules are further configured to disable interrupts until the initialized state information has been applied to the corresponding locations in the volatile memory.

18. The system of claim 13, further comprising:
a processor configured to process the one or more modules.
